(19) United States
(12) Patent Application Publication
(10) Pub. No.: US 2023/0254048 A1
(43) Pub. Date: Aug. 10, 2023

(54) METHODS AND APPARATUS FOR HIGH-SPEED COHERENT OPTICAL INTERCONNECTS

(71) Applicant: Indian Institute of Technology Bombay, Mumbai (IN)

(72) Inventors: Shalabh Gupta, Mumbai (IN); Aboobackkar Sidhique, Mumbai (IN)

(21) Appl. No.: 18/165,668

(22) Filed: Feb. 7, 2023

(30) Foreign Application Priority Data
Feb. 7, 2022 (IN) 202221006509

(51) Int. Cl. H04B 10/80; H04B 10/294; H04B 10/61

(52) U.S. Cl. CPC H04B 10/801; H04B 10/294; H04B 10/6151

(57) ABSTRACT

Present disclosure provides a self-homodyne coherent (SHC) system (100) for high-speed coherent optical interconnects, the SHC (100) comprises a first transceiver (101a) and a second transceiver (101b), each of the first transceiver (101a) and one second transceiver (101b) comprises adaptive polarization controller (401), a multi-core fiber link (103) connecting first transceiver (101a) to second transceiver (101b), the first transceiver (101a) is connected to first core for forward transmission of a first signal to the second transceiver (101b), and the first transceiver (101a) is connected to second core for backward transmission of a second signal from the second transceiver (101b), and adaptive polarization controller (401) of the first transceiver (101a) and the second transceiver (101b) is configured to control a coupled optical signal polarization associated with the first signal received at second transceiver (101b) and control a coupled optical signal polarization associated with second signal received at first transceiver (101a)..

### PRIORITY DETAILS

The present application is based on, and claims priority from, IN Application Number 202221006509, filed on 7^{th} February, 2022, the disclosure of which is hereby incorporated by reference herein.

### TECHNICAL FIELD

This embodiment relates to optical communication systems, and more particularly to a mechanism for mobile security, and a method and apparatus for high-speed coherent optical interconnects between two or more transceivers.

### BACKGROUND

In general, self-homodyne coherent links provide a power efficient solution for high-capacity short-reach optical interconnects (DCIs) and may replace conventional PAM-4 based short-reach DCIs in near future. The self-homodyne coherent links are more tolerant to laser phase noise and require simpler receiver side signal processing, as the carrier for coherent demodulation is readily available, which also simplifies the processing required in the electronic domain. More tolerance to laser phase noise makes the use of power efficient uncooled or cooled DFB lasers possible, while simpler electronic processing can greatly reduce the power consumption of the electronics. Fiber multiplexed carrier based self-homodyne (FMC-SH) links use one fiber for the transmission of the carrier and one fiber for the transmission of the signal. Therefore, two dedicated fibers are needed for any short reach communication link. A polarization multiplexed carrier based self-homodyne (PMC-SH) system uses one of the orthogonal polarized channels to transmit the carrier and another orthogonal polarized channel to transmit the signal. This technique therefore requires only a single fiber for a short reach communication link. Thus, it is desired to address the above mentioned disadvantages or other shortcomings or at least provide a useful alternative.

### SUMMARY

Accordingly, the embodiments herein is to provide a self-homodyne coherent (SHC) system for high-speed coherent optical interconnects, the SHC comprises a first transceiver and a second transceiver, each of the first transceiver and one second transceiver comprises adaptive polarization controller, a multi-core fiber link connecting first transceiver to second transceiver, the first transceiver is connected to first core for forward transmission of a first signal to the second transceiver, and the first transceiver is connected to second core for backward transmission of a second signal from the second transceiver, and adaptive polarization controller of the first transceiver and the second transceiver is configured to control a coupled optical signal polarization associated with the first signal received at second transceiver and control a coupled optical signal polarization associated with second signal received at first transceiver.

In an embodiments, the first signal and the second signal are a coherent modulated signals with carriers in orthogonal polarization propagating bi-directionally

In another embodiments, the carrier in the orthogonal polarization and the coherent modulated signal is separated by the at least one adaptive polarization controller of each of the at least one first transceiver and the at least one second transceiver during receiving the first signal.

In another embodiments, the carrier in the orthogonal polarization and the coherent modulated signal is separated by the at least one adaptive polarization controller of each of the at least one first transceiver and the at least one second transceiver during receiving the second signal.

In another embodiments, the first signal comprises a plurality of wavelengths.

In another embodiments, the at least one second transceiver comprises at least one wavelength division multiplexer configured to multiplex the plurality of wavelengths received from the at least one first transceiver.

In another embodiments, at least one first transceiver comprises at least one wavelength division multiplexer configured to multiplex the plurality of wavelengths received from the at least one second transceiver.

In another embodiments, the adjacent cores of the multi-core fiber link configured to carry signals of non-overlapping wavelengths of the plurality of wavelengths.

In another embodiments, the adjacent cores of the multi-core fiber link configured to carry the signals in opposite direction.

In another embodiments, at least one adaptive polarization controller of the at least one second transceiver is configured to receive the first signal, split the first signal into corresponding dual polarization signals, determine a difference in power between the dual polarization signals of the first signal; and equalize the dual polarization signals of the first signal based on a feedback parameter, wherein the feedback parameter is determined based on signal processing technique.

In another embodiments, at least one adaptive polarization controller of the at least one first transceiver is configured to receive the second signal, split the second signal into corresponding dual polarization signals, determine a difference in power between the dual polarization signals of the second signal, and equalize the dual polarization signals of the second signal based on a feedback parameter, wherein the feedback parameter is determined based on signal processing technique.

Accordingly, the embodiments herein is to provide an adaptive polarization controller configured to receive at least one signal, split the at least one signal into corresponding dual polarization signals, determine a difference in power between the dual polarization signals of the at least one signal; and equalize the dual polarization signals of the signal based on a feedback parameter, wherein the feedback parameter is determined based on signal processing technique.

In an embodiments, the adaptive polarization controller comprises, a coupler configured to split the at least one received signal into corresponding dual polarization signals, at least one multiplexer configured to multiplex the dual polarization signals, at least one attenuator configured to adaptively control a coupled optical power associated with the at least one signal based on the feedback parameter.

In another embodiments, the adaptive polarization controller comprises a control signal generator configured to determine the feedback parameter based on the polarization dependent crosstalk between the dual polarization signals of the at least one signal, and a control unit configured to provide the feedback parameter to the at least one attenuator.

### BRIEF DESCRIPTION OF FIGURES

This embodiment is illustrated in the accompanying drawings, through out which like reference letters indicate corresponding parts in the various figures. The embodiments herein will be better understood from the following description with reference to the drawings, in which:

FIG. 1A illustrates a bidirectional WDM-SDM-PDM self-homodyne link using two separate SMFs with polarization multiplexed carrier, according to the prior art;

FIG. 1B illustrates a conventional adaptive polarization controller (APC), according to the prior art;

FIG. 1C illustrates a conventional adaptive polarization controller (APC) for wavelength division multiplexing (WDM) transceivers, according to the prior art;

FIG. 2 illustrates a bidirectional WDM-SDM-PDM self-homodyne link using four-core fibers with spatial multiplexed carrier, according to the embodiments as disclosed herein;

FIG. 3 illustrates a bidirectional WDM-SDM-PDM self-homodyne link using four-core fibers with polarization multiplexed carrier, according to the embodiments as disclosed herein;

FIG. 4 illustrates an adaptive polarization dependent loss adjustment, according to the embodiments as disclosed herein;

FIG. 5 illustrates a conceptual block diagram of self-homodyne coherent bidirectional link using 4-core single-mode fiber with polarization, according to the embodiments as disclosed herein;

FIG. 6 illustrates a cross-sectional view of the multi-core fiber, according to the embodiments as disclosed herein;

FIG. 7 illustrates bidirectional link using four-core fiber, according to the embodiments as disclosed herein; and

FIG. 8 illustrates polarization dependent loss insensitive adaptive polarization controller for multiple wavelengths, according to the embodiments as disclosed herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Prior to describing the present embodiment detail, it is useful to provide definitions for key terms and concepts used herein. Unless defined otherwise, all technical and scientific terms used herein have the same meaning as commonly understood by one of ordinary skill in the art.

Accordingly, the embodiments herein is to provide a self-homodyne coherent (SHC) system for high-speed coherent optical interconnects, the SHC comprises a first transceiver and a second transceiver, each of the first transceiver and one second transceiver comprises adaptive polarization controller, a multi-core fiber link connecting first transceiver to second transceiver, the first transceiver is connected to first core for forward transmission of a first signal to the second transceiver, and the first transceiver is connected to second core for backward transmission of a second signal from the second transceiver, and adaptive polarization controller of the first transceiver and the second transceiver is configured to control a coupled optical signal polarization associated with the first signal received at second transceiver and control a coupled optical signal polarization associated with second signal received at first transceiver.

Accordingly, the embodiments herein is to provide an adaptive polarization controller configured to receive at least one signal, split the at least one signal into corresponding dual polarization signals, determine a difference in power between the dual polarization signals of the at least one signal; and equalize the dual polarization signals of the signal based on a feedback parameter, wherein the feedback parameter is determined based on signal processing technique.

In conventional method, the Fiber multiplexed carrier based self-homodyne (FMC-SH) links use one fiber for the transmission of the carrier and one fiber for the transmission of the signal. Therefore, two dedicated fibers are needed for any short reach communication link.

Unlike the conventional method, the proposed invention demonstrates a polarization multiplexed carrier based self-homodyne (PMC SH) system (100) that uses one of the orthogonal polarized channels to transmit the carrier and another orthogonal polarized channel to transmit the signal. This technique requires only a single fiber (103) for a short reach communication link. SHC bidirectional link using carrier along with an IQ modulated signal (one in each direction) and dual polarization IQ modulated signals in the other two cores and the high-speed coherent optical interconnects includes a new PMC-SH link which utilizes all the orthogonal polarization in the wavelength division multiplexed (WDM) and spatial division multiplexed (SDM) channels to increase the overall channel capacity by 50 percent compare to the conventional method. This example assumes that the number of cores in the fiber is 4 (or the number of cores utilized is 4). If the number of cores is increased, for example in a 6 core fiber, in each direction, one core can be used for transmitting the signal with the polarization multiplexed carrier, and two cores for transmitting polarization multiplexed signals in each in each independent polarization.

In another embodiment, the proposed method uses (weakly coupled) FCFs with core/polarization multiplexed carriers for unidirectional or bidirectional short reach high-capacity links. Along with spatial division multiplexing (SDM) in (weakly coupled) FCFs, a combination of the following approaches can be used which includes but not limited to:

1. Wavelength division multiplexing (WDM) to multiplex various unmodulated carriers and modulated signals, in the same or opposite directions.

2. Polarization multiplexing (PM) to multiplex carrier and signal in two orthogonal polarizations.

3. Space division multiplexing (SDM) to multiplex unmodulated carriers and modulated signals in different cores of the fibers (103), in the same or opposite directions.

4. In addition to these, various digital modulation formats that go well with coherent techniques, such as 4-QAM, 16-QAM, 8-PSK, 32-QAM and 64-QAM, can be used.

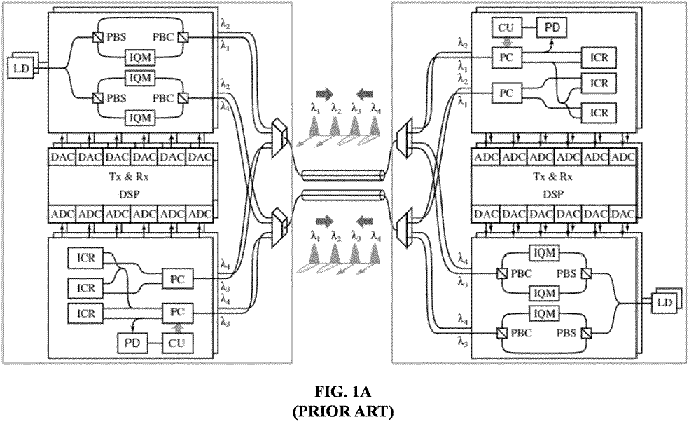

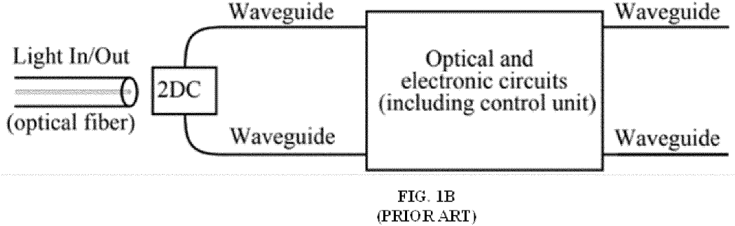

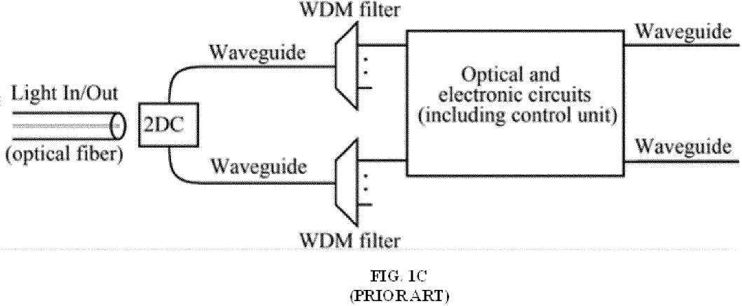

Referring now to the drawings and more particularly to FIGS. 1 through 8, where similar reference characters denote corresponding features consistently throughout the figure, these are shown preferred embodiments.

FIG. 1A illustrates a bidirectional WDM-SDM-PDM self-homodyne link (100) using two separate SMFs with polarization multiplexed carrier, according to the embodiments as disclosed herein.

Referring to the FIG. 1, the bidirectional WDM-SDM-PDM self-homodyne link (100) using two separate SMFs with polarization multiplexed carrier is provided. Here, LD: laser diode; PBS: polarization beam splitter; PBC: polarization beam combiner; IQM: in-phase and quadrature-phase modulator; PC: polarization controller; ICR: integrated coherent receiver; PD: photodetector; CU: control unit; DAC: digital-to-analog converter; ADC: analog-to-digital converter; DSP: digital signal processing.

FIG. 1B illustrates a conventional adaptive polarization controller (APC), according to the prior art;

Referring to FIG. 1B illustrates a conventional adaptive polarization controller (APC) which adaptively separates polarization multiplexed signals (in orthogonal polarizations) using an optical and electronic circuit module which includes a control unit.

FIG. 1C illustrates a conventional adaptive polarization controller (APC) for wavelength division multiplexing (WDM) transceivers, according to the prior art;

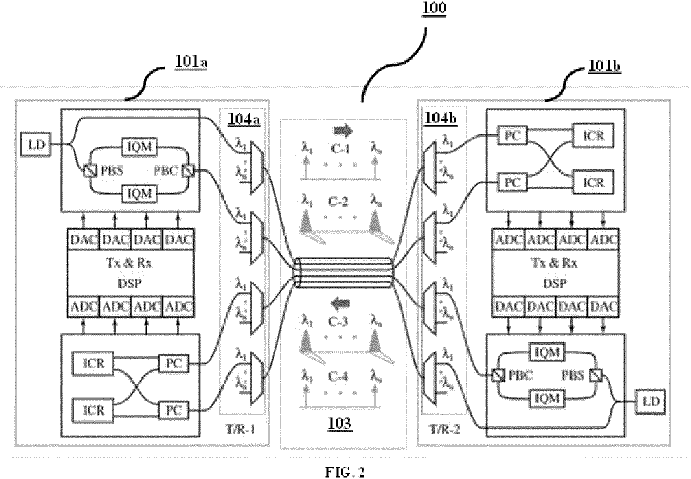

Referring to FIG. 1C illustrates the conventional adaptive polarization controllers and polarization changes in the system are wavelength dependent and may need separate adaptive polarization controllers for wavelength division multiplexing (WDM) based transceivers. FIG. 2 shows a conventional adaptive polarization controller for WDM based transceivers. Here, the separated signals from two-dimensional coupler (2DC) are fed to WDM modules and corresponding outputs of each WDM channel are fed to optical and electronic circuit modules. These modules adaptively separate signals in each polarization with the help of control units.

The current IEEE Ethernet standards for 800 Gbps short-reach (10 km, 40 km, etc.) DCIs which are being developed used two single mode fibers (SMFs) (103) for bidirectional transmission. The proposed method includes a new PMC-SH link which utilizes all the orthogonal polarization in the wavelength division multiplexed (WDM) and spatial division multiplexed (SDM) channels to increase the overall channel capacity by 50 percent and is shown in the FIG. 1. In this scheme, the carriers are multiplexed with single-polarized coherent modulated signals (‘x’ Gbaud and m-QAM) and sent through the first and second WDM channels of the first SMF. Dual-polarized coherent modulated signals (‘x’ Gbaud and m-QAM) are sent through the first and second WDM channels of the second SMF. At the receiver, carriers received through the first SMF are separated from modulated signals using a power minimization algorithm based adaptive polarization controller. These carriers are used as local oscillators for all the coherent modulated signals received through the first and second WDM channels. Similarly third and fourth WDM channels are used for backward transmission. In another combination, transmitting all the polarization multiplexed carriers and coherent modulated signals through the first SMF and all the dual-polarized coherent modulated signals through the second SMF. Similarly, various other combinations of choosing WDM channels for better crosstalk performance can be tried. A bidirectional link with an overall capacity of 1.6 Tbps can be achieved using four WDM channels with 80 GBaud, 16-QAM modulated signals.

FIG. 2 illustrates a bidirectional WDM-SDM-PDM self-homodyne link (100) using four-core fibers (103) with spatial multiplexed carrier, according to the embodiments as disclosed herein.

The core multiplexed carrier based self-homodyne (CMC-SH) (100) technique proposed for long-haul communication (which can be implemented with multi-core fibers) is an attractive candidate for future high-capacity short-reach interconnects. Like other self-homodyne (100) techniques, CMC-SH links are more tolerant to laser phase noise and can work with uncooled DFB laser sources. The drawback of CMC-SH links that use tightly coupled multicore fibers (103) is its high inter-core cross-talk. However, the cross-talk can be very low in case of (weakly coupled) multi-core fibers (103), and can be even lower in (weakly coupled) few-core fibers (103) (FCFs). Also, with FCFs, coupling of light to/from photonic ICs may be easier, and may help in providing a compact solution. Hence, they can be used for short-reach applications, such as the DCIs, wherein the overall capacity is less compared to long-haul inks, but the cost, power and size constraints are tighter.

The proposed method uses (weakly coupled) FCFs with core/polarization multiplexed carriers for unidirectional or bidirectional short reach high-capacity links. Along with spatial division multiplexing (SDM) in (weakly coupled) FCFs, a combination of the following approaches can be used:

1. Wavelength division multiplexing (WDM) to multiplex various unmodulated carriers and modulated signals, in the same or opposite directions.

2. Polarization multiplexing (PM) to multiplex carrier and signal in two orthogonal polarizations.

3. Space division multiplexing (SDM) to multiplex unmodulated carriers and modulated signals in different cores of the fibers (103), in the same or opposite directions.

4. In addition to these, various digital modulation formats that go well with coherent techniques, such as 4-QAM, 16-QAM, 8-PSK, 32-QAM and 64-QAM, can be used.

The link which uses a combination of the above mentioned approaches in an FCF with self-homodyne (100) coherent detection, as an FCF-SH link. Different implementations are possible using various permutations and combinations of WDM, PM, SDM and modulation formats, based on the capacity requirement for the link, the limitations in the fiber (103) and the limitations in the electronic hardware. The possible implementations as examples have been discussed with respect to subsequent diagrams.

Referring to the FIG. 2, the bidirectional WDM-SDM-PDM self-homodyne link (100) using four-core fibers (103) with spatial multiplexed carrier is provided. Here, LD: laser diode; PBS: polarization beam splitter; PBC: polarization beam combiner; IQM: in-phase and quadrature-phase modulator; PC: polarization controller; ICR: integrated coherent receiver; PD: photodetector; CU: control unit; DAC: digital-to-analog converter; ADC: analog-to-digital converter; DSP: digital signal processing.

The conceptual block diagram of the link shown in the FIG. 2 uses two cores for forward transmission, and two cores are used for backward transmission to achieve a bidirectional link using 4-core fiber (103). In forward transmission, for each wavelength, the carrier is sent through the first core and a dual-polarized coherent modulated signal (‘x’ Gbaud and m-QAM) is sent through the second core. At the receiver, after wavelength demultiplexing, the carrier transmitted through the first core of the fiber (103) is used as a local oscillator for the demodulation of dual-polarized signal, which is received through the second core of the 4-core fiber (103). Similarly, the third and fourth cores are used for backward transmission. Thus, a bidirectional link with an overall capacity of 2 × 1.6 Tbps can be achieved using four WDM (104a) channels with 60 GBaud, 16-QAM modulated signals (wherein the raw bit-rate in each direction, along with FEC overheads, would be 1.92 Tbps).

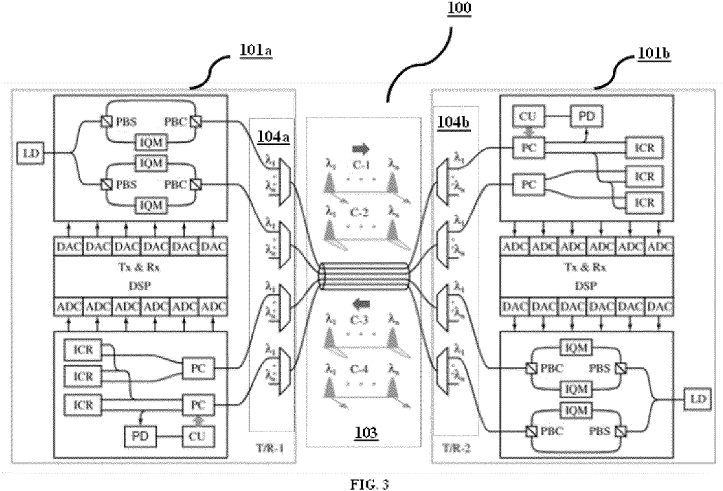

FIG. 3 illustrates a bidirectional WDM-SDM-PDM self-homodyne link (100) using four-core fibers (103) with polarization multiplexed carrier. Referring to the FIG. 3, includes LD: laser diode; PBS: polarization beam splitter; PBC: polarization beam combiner; IQM: in-phase and quadrature-phase modulator; PC: polarization controller; ICR: integrated coherent receiver; PD: photodetector; CU: control unit; DAC: digital-to-analog converter; ADC: analog-to-digital converter; DSP: digital signal processing.

The architecture fully utilizes the orthogonality of polarizations. Here, in the first and the fourth cores, which were used for sending only the carrier in the previous example (as provided in the FIG. 2), for each wavelength, multiplex an IQ modulated signal (‘x’ G baud and m-QAM) and the carrier in orthogonal polarizations. A dual-polarized coherent modulated signal (‘x’ Gbaud and m-QAM) is sent through the second core of the fiber (103). At the receiver, after wavelength demultiplexing, a power minimization based adaptive polarization controller (401) may be used to separate out the carrier and the modulated signal. This carrier is also used as the local oscillator for the demodulation of both the modulated signals received through the first and second cores of the fiber (103). Similarly the third and fourth cores can be used for backward transmission. A bidirectional link with an overall capacity of 2×1.6 Tbps can be achieved using four WDM channels, 40 GBaud transmission of 16-QAM signals. The proposed link can be scaled to 2 × 3.2 Tbps in future by doubling the baud-rate to 80 Gbaud (with the availability of higher speed electronics). In all the above cases, the overall link capacity can be improved by increasing the number of WDM (104a) channels. In these links, in addition to the above mentioned techniques, standard coherent digital and/or analog domain signal processing techniques will have to be used for transmit side signal modulation and receiver side demodulation of signals. It may be possible to replace the Tx/Rx side ADCs/DACs and DSP (shown in the figures) with analog domain signal processing solutions. In addition, standard optical amplification techniques may have to be used to increase the reach and improve the SNR.

The major advantage of an FCF-SH link is that it does not require or minimal at the receiver, as the carrier is transmitted along with the signal, and any drift in the laser frequency due to the channel will apply both to the carrier and the signal simultaneously. Because of this aspect, such links can utilize uncooled DFB lasers, and simpler and lower power electronics. Furthermore, these links can be implemented with an integrated solution of EICs (electronic ICs) and PICs (photonic ICs) in a small form-factor because of lower thermal footprint, single fiber (103), and simpler optics and electronics. Therefore, the FCF-SH links would be the ideal for future DCI applications.

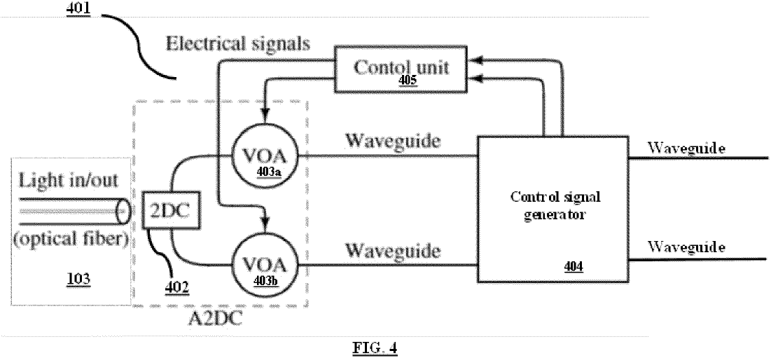

FIG. 4 illustrates a polarization management controller (401) for adaptive polarization dependent loss adjustment, according to the embodiments as disclosed herein. Referring to the FIG. 4, the adaptive polarization dependent loss adjustment is provided using the polarization management controller (401). The polarization management controller (401) includes VOA (403a): Variable Optical Attenuator; 2DC: 2-Dimensional (dual polarization) Coupler; A2DC: Active 2-Dimensional (dual polarization) Coupler (402), optical and control signal generator (404), and control unit (405). The polarization dependent loss insensitive polarization controller is interchangeably referred as polarization management controller (401) throughout the specification.

The conventional adaptive polarization controllers are sensitive to polarization dependent losses (PDL) in the system. FIG. 4 illustrates a PDL insensitive adaptive polarization controller for a transceiver. The attenuation levels in the variable optical attenuators (VOAs) are adaptively adjusted to compensate for the PDL.

Typically, to couple a dual-polarization optical signal from an optical fiber (103) into a photonic IC and split its polarization components into two waveguides, or to couple and polarization multiplex signals from a photonic IC into orthogonal polarizations of a fiber (103), 2D (i.e. dual polarization) couplers are used. The 2D couplers (2DCs) may comprise an edge coupler along with a polarization splitter-rotator (PSR), or a 2D vertical grating coupler (2D-VGC). These 2DCs exhibit polarization dependent loss (PDL) that can cause polarization crosstalk if the polarized signals are rotated, or if they undergo polarization mode dispersion before being coupled from the fiber (103) into the photonic IC. The PDL of the 2DCs may result in various other problems in the system. Several techniques have been developed to overcome this problem, which are aimed at designing better 2DCs. However, the method propose an adaptive (active and automatic) polarization dependent loss adjustment solution to overcome this problem. In this mechanism, adding tunable loss components (i.e. VOAs or variable optical attenuators) (403a-N) in the waveguides of the photonic IC that couple incoming light from the optical fiber (103) into the waveguides going to other parts of the photonic IC through the 2DC, or the waveguides that couple light corresponding to the two orthogonal polarization components from the photonic IC into the fiber (103) through the 2DC, as shown in the FIG. 4. By adaptively tuning the losses in the two waveguides, the polarization crosstalk effects or other effects of PDL can be minimized or mitigated. For example, this technique can be used when the modulated signals with polarization multiplexing, or polarization multiplexed modulated signal and carrier are coupled into the chip in the three architectures proposed in the first section.

Additionally, these VOAs (403a-N) may be used for adaptively controlling the coupled optical power levels. Various approaches can be used for adaptive control of losses (or attenuation) in the two waveguides. For example, one approach, the received constellation or BER (bit error rate) can be observed and losses (or attenuation) in the two waveguides may be adjusted in such a way that the BER (bit error rate) in the system is minimized, using a feedback mechanism. Considering the combination of 2DC (402) with the attenuators (403a-N) in the waveguides as an active 2DC (402) (or A2DC) block that can achieve effectively negligible PDL. This block may also be used for intentionally adding imbalance in the coupling efficiencies for the two polarizations, for example, to compensate for the PDLs in other components of the system, using adaptive mechanisms (for example, using the approach for adaptation discussed above).

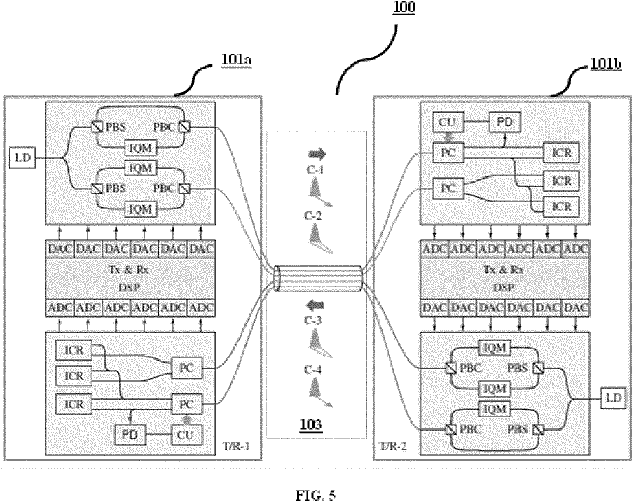

FIG. 5 illustrates a conceptual block diagram of self-homodyne coherent bidirectional link (100) using 4-core single-mode fiber (103) with polarization, according to the embodiments as disclosed herein;

Referring to FIG. 5 illustrates ADC: analog-to-digital converter; CU: control unit; DAC: digital-to-analog converter; ICR: integrated coherent receiver; IQM: IQ modulator; LD: laser diode; PBC/PBS: polarization beam combiner/splitter; PC: polarization controller; PD: photodetector.

The conceptual block diagram of the proposed polarization multiplexed carrier based self-homodyne (PMC-SH) bidirectional link (100) using 4-core fiber (103) is illustrated in FIG. 5. It uses two cores (C1 and C2) for forward transmission, and two cores (C3 and C4) for backward transmission to achieve a bidirectional link using a 4-core SMF. In forward transmission, multiplex a coherent modulated signal (‘x’ Gbaud and m-QAM) with the carrier in orthogonal polarizations and send it through the first core of the 4-core fiber (103). A dual-polarized coherent modulated signal (‘x’ Gbaud and m-QAM) is sent through the second core. At the receiver, a power minimization based adaptive polarization controller (401) is used to separate out the carrier and the modulated signal. This carrier is used as the local oscillator for the demodulation of both the polarization multiplexed modulated signals received through the first and second cores of the fiber (103). Similarly the third and fourth cores are used for backward transmission. In this bidirectional link, standard coherent digital signal processing (DSP) techniques will have to be used for transmitter-end signal modulation and receiver-end demodulation of the signals. Receiver side DSP can be replaced with analog signal processing solutions to further reduce the power consumption. In addition, standard optical amplification techniques can be used to increase the reach and improve the signal-to-noise ratio (SNR).

The SHC links which use two separate fibers (103) for the transmission of the carrier and the modulated signal, the phase noise arises mainly due to the length mismatch (between the carrier and the modulated signal) and the laser linewidth. The unique feature of SHC link using MCF is that length of all the cores are perfectly matched hence the length mismatch between the carrier and the dual-polarized modulated signal (sent through the different cores) is negligible. In addition, the length mismatch between the carrier and the single-polarized modulated signal (which are multiplexed in orthogonal polarization and sent through the same core) is also very low. Hence, the overall phase noise arising in the proposed SHC link is very small and is more linewidth tolerant.

In a comparative approach, a bidirectional link can be achieved using two standard single mode fibers (SSMFs) (103) of the same length with two wavelength division multiplexed (WDM) channels. The first WDM channel is used for the forward transmission and the second WDM channel is used for the backward transmission. This scheme can be easily added with the existing links which are established using duplex fibers (103). The drawback of this link is that if any break happens in one of the SSMF after deployment, the delay between two fibers (103) needs to be estimated perfectly to reduce the complexity of carrier phase recovery circuits.

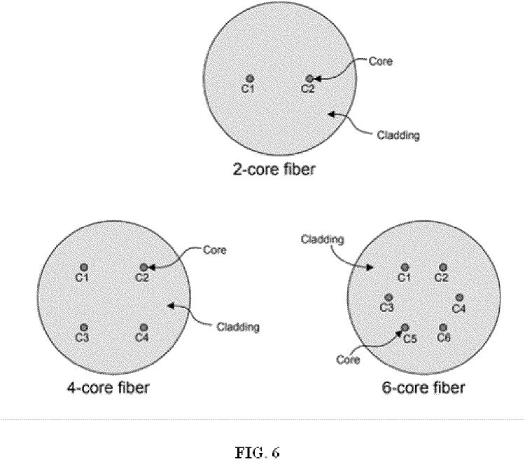

FIG. 6 illustrates a cross-sectional view of the multi-core fiber, according to the embodiments as disclosed herein.

Referring to FIG. 6 illustrates the 4-core fiber consists of 4 cores in a common cladding layer, such that each of the cores independently guides light signals, which may include a carrier, a modulated signal, a polarization multiplexed carrier and modulated signal combination, or a polarization multiplexed modulated signal and modulated signal combination. Similarly, the 6-core fiber consists of 6 cores in a common cladding layer, such that each of the cores independently guides light signals, which may include a carrier, a modulated signal, a polarization multiplexed carrier and modulated signal combination, or a polarization multiplexed modulated signal and modulated signal combination. A two-core fiber can be used for transmitting one modulated signal and polarization multiplexed carrier in one direction and another modulated signal and polarization multiplexed carrier in the opposite direction to achieve bidirectional transmission. In actuality, the multi-core fiber may consist of n cores, where n is an integer, with typically a value between 2 and 50.

Bidirectional link using four-core fiber with polarization multiplexed carrier. The co-propagating signals (signals propagating in the same direction) are sent through cores that are diagonally opposite, i.e. not adjacent to (or not next to) to reduce the inter-core crosstalk which is more prominent for co-propagating signals. For example, in the 4-core fiber (shown above and the full system below), it may be beneficial to send signals propagating in one direction in C1 and C4 that are diagonally opposite and not adjacent to each other and in the opposite direction in C2 and C3 that are diagonally opposite and not adjacent to each other. Similarly, for the 6-core fiber (shown above), it may be beneficial to send signals propagating in one direction in C1, C4 and C5 (none of which are adjacent to each other) and in the opposite direction in C2, C3 and C6 (none of which are adjacent to each other).

The inter-core crosstalk can be reduced further by using non-overlapping wavelengths for forward and backward transmission in adjacent cores. For example, in a four core (shown in the figure), wavelength-1 and wavelength-3 can be used in C1 and C4, and wavelength-2 and wavelength-4 can be used in C1 and C4, which would have less crosstalk effects.

The inter-core crosstalk can be reduced further by using different non-overlapping wavelengths for forward wavelengths for forward and backward transmission in adjacent cores. For example, in a four core (illustrated in the figure), wavelength-1 and wavelength-3 can be used in C1 and C4, and wavelength-2 and wavelength-4 can be used in C1 and C4, which would have less crosstalk effects.

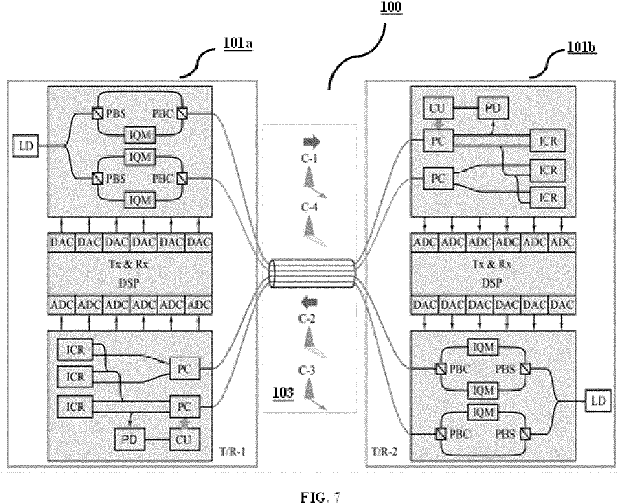

FIG. 7 illustrates bidirectional link using four-core fiber, according to the embodiments as disclosed herein.

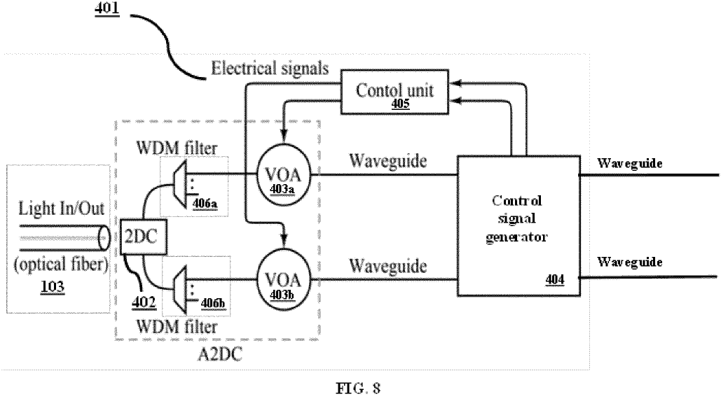

Referring FIG. 7 illustrates directions of technique can be extended to an n-core fiber. This technique can also be used in a bidirectional link using four-core fiber illustrated in FIG. 7 where carrier signals are sent through independent cores (without multiplexing with the modulated signals). This technique can also be used with wavelength division multiplexed links as illustrated in FIG. 7 and FIG. 8.

FIG. 8 illustrates polarization dependent loss insensitive adaptive polarization controller for multiple wavelengths, according to the embodiments as disclosed herein.

Referring to FIG. 8 illustrates the polarization dependent loss insensitive adaptive polarization controller for multiple wavelengths can be implemented. The group delay mismatch between the channels in a self-homodyne coherent link increases carrier frequency offset and phase noise. This leads to the degradation of the received signal quality hence reduces the laser linewidth tolerance. Symmetric multi-core fibers solve this issue to a great extent since the change in refractive index between each core is minimal in symmetric multi-core fiber compared to asymmetric multi-core fiber.

The adaptive polarization controller and polarization changes in the system are wavelength dependent and may need separate adaptive polarization controllers for wavelength division multiplexing (WDM) (406a) based transceivers. FIG. 8 illustrates a PDL insensitive adaptive polarization controller for WDM based transceivers. Here, the separated signals from two-dimensional coupler (2DC) are fed to WDM (406a) modules and corresponding outputs of each WDM channel are fed to VOAs and the attenuation levels are adaptively adjusted to compensate for the polarization dependent losses (PDL). The VOA (403a) outputs are fed to optical and electronic circuit modules. These modules adaptively separate signals in each polarization with the help of control units.

The major advantage of the FCF based SHC link is that it provides a simple, low cost, small footprint solution suitable for high-capacity DCIs because: i) uncooled DFB lasers can be used, as frequency drift and phase noise become less significant due to self-homodyning; ii) reduced carrier phase synchronization severity leads to greatly simplified electronics; and iii) single fiber (103) for the bi-directional transmission greatly simplifies and miniaturize the package design, and makes it more reliable. With two wavelengths and 80 Gbaud 16-QAM signaling, 2×1.6 Tbps bidirectional links are easily achievable with four core fibers. This can be scaled by increasing the baud rates, the number of cores in the fiber (103) and/or the number of wavelengths, for future DCI and optical interconnect applications.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A self-homodyne coherent (SHC) system (100) for high-speed coherent optical interconnects, wherein the SHC (100) system comprises:
at least one first transceiver (101a) and at least one second transceiver (101b) of a plurality of transceivers (101a-N), wherein each of the at least one first transceiver (101a) and the at least one second transceiver (101b) comprises at least one adaptive polarization controller (401);
a multi-core fiber link (103) connecting the at least one first transceiver (101a) to the at least one second transceiver (101b) of the plurality of transceivers (101a-N);
wherein the at least one first transceiver (101a) is connected to at least one first core for forward transmission of a first signal to the at least one second transceiver (101b) respectively, and wherein the at least one first transceiver (101a) is connected to at least one second core for backward transmission of a second signal from the at least one second transceiver (101b) respectively, and
wherein the at least one adaptive polarization controller (401) of each of the at least one first transceiver (101a) and the at least one second transceiver (101b) is configured to adaptively control a coupled optical signal polarization associated with the first signal received at the at least one second transceiver (101b) and adaptively control a coupled optical signal polarization associated with the second signal received at the at least one first transceiver (101a).

2. The SHC system as claimed in claim 1, wherein the first signal and the second signal are a coherent modulated signals with carriers in orthogonal polarization propagating bi-directionally.

3. The SHC system as claimed in claim 2, wherein the carrier in the orthogonal polarization and the coherent modulated signal is separated by the at least one adaptive polarization controller (401) of each of the at least one first transceiver (101a) and the at least one second transceiver (101b) during receiving the first signal.

4. The SHC system as claimed in claim 2, wherein the carrier in the orthogonal polarization and the coherent modulated signal is separated by the at least one adaptive polarization controller (401) of each of the at least one first transceiver (101a) and the at least one second transceiver (101b) during receiving the second signal.

5. The SHC system as claimed in claim 1, wherein the first signal comprises a plurality of wavelengths.

6. The SHC system as claimed in claim 1, wherein the at least one second transceiver (101b) comprises:
at least one wavelength division multiplexer (104b) configured to multiplex the plurality of wavelengths received from the at least one first transceiver (101a).

7. The SHC system as claimed in claim 1, wherein the at least one first transceiver (101a) comprises:
at least one wavelength division multiplexer (104a) configured to multiplex the plurality of wavelengths received from the at least one second transceiver (101b).

8. The SHC system as claimed in claim 1, wherein adjacent cores of the multi-core fiber link (103) configured to carry signals of non-overlapping wavelengths of the plurality of wavelengths.

9. The SHC system as claimed in claim 1, wherein adjacent cores of the multi-core fiber link (103) configured to carry the signals in opposite direction.

10. The SHC system as claimed in claim 1, wherein the at least one adaptive polarization controller (401) of the at least one second transceiver (101b) is configured to:
receive the first signal;
split the first signal into corresponding dual polarization signals;
determine a difference in power between the dual polarization signals of the first signal; and
equalize the dual polarization signals of the first signal based on a feedback parameter, wherein the feedback parameter is determined based on signal processing technique.

11. The SHC system as claimed in claim 1, wherein the at least one adaptive polarization controller (401) of the at least one first transceiver (101a) is configured to:
receive the second signal;
split the second signal into corresponding dual polarization signals;
determine a difference in power between the dual polarization signals of the second signal; and
equalize the dual polarization signals of the second signal based on a feedback parameter, wherein the feedback parameter is determined based on signal processing technique.

12. An adaptive polarization controller (401) configured to:
receive at least one signal;
split the at least one signal into corresponding dual polarization signals;
determine a difference in power between the dual polarization signals of the at least one signal; and
equalize the dual polarization signals of the signal based on a feedback parameter, wherein the feedback parameter is determined based on signal processing technique.

13. The adaptive polarization controller (401) as claimed in claim 12, wherein the adaptive polarization controller (401) comprises:
a coupler (402) configured to split the at least one received signal into corresponding dual polarization signals:
at least one multiplexer (406a) configured to multiplex the dual polarization signals;
at least one attenuator (403a) configured to adaptively control a coupled optical power associated with the at least one signal based on the feedback parameter.

14. The adaptive polarization controller (401) as claimed in claim 12, wherein the adaptive polarization controller (401) comprises:
a control signal generator (404) configured to determine the feedback parameter based on the polarization dependent crosstalk between the dual polarization signals of the at least one signal; and
a control unit (405) configured to provide the feedback parameter to the at least one attenuator (403a).
